(19) United States
(12) Patent Application Publication
(10) Pub. No.: US 2026/0070160 A1
(43) Pub. Date: Mar. 12, 2026

(54) WELDING DEVICE AND METHOD FOR WELDING

(71) Applicant: Liebherr-Aerospace Lindenberg GmbH, Lindenberg (DE)

(72) Inventors: Martin DÖHRING, Lindenberg (DE); Daniel ZIMMERMANN, Wangen (DE)

(21) Appl. No.: 19/325,287

(22) Filed: Sep. 10, 2025

(30) Foreign Application Priority Data
Sep. 12, 2024 (DE) 10 2024 126 238.9

(51) Int. Cl. B23K 28/00

(52) U.S. Cl. CPC B23K 28/00

(57) ABSTRACT

The disclosure relates to a welding device for welding components which comprises a linear unit that is configured for moving a component placed thereon back and forth along one direction, an optical measuring unit comprising a detection region directed onto a portion of the linear unit in order to measure a component placed on the linear unit, and a welding unit which is configured for lifting a first component, optionally a sphere, from the linear unit and, after displacement of the linear unit, for welding it to a second component, optionally a wire, placed in the detection region.

### CROSS REFERENCE TO RELATED APPLICATION

The present application claims priority to German Patent Application No. 10 2024 126 238.9 filed on Sep. 12, 2024. The entire contents of the above-listed application are hereby incorporated by reference for all purposes.

### TECHNICAL FIELD

The present disclosure relates to a welding device and a method for welding.

### BACKGROUND

In modern manufacturing technology, precision and reliability are of decisive importance, in particular in safety-critical applications such as air travel. A welding device and an optimized method for welding play an important role in the manufacture of components used by aircraft. In order to be able to check the exactness of a welding procedure that has been performed, after completion of the welding procedure a concentricity test is essential, in order to ensure that the components that are welded together are exactly aligned relative to one another. This applies by way of example for welding of components for electrohydraulic servo valves (EHSV), which are typically used for controlling air-guiding surfaces in aircraft.

### SUMMARY

According to the prior art, the components were inserted individually and by hand into a rigid clamping device, in which the two components are positioned relative to one another during a welding procedure. After the welding process, the parts were removed from the clamping device and checked in a rotary device for concentricity using a dial gauge. If the concentricity was outside the predetermined tolerance, the welded component was scrap, and therefore the procedure was carried out once again with a newly set clamping device. In this case, the setting of the clamping device is changed for as long until the required concentricity corresponding to the tolerances was reached. Performing this procedure leads to a high scrap rate. In addition, this process has to be performed again upon each product change, and therefore it is not possible for example to weld differently dimensioned components with one setting of the clamping device.

The concentricity test that takes place after the welding serves to check the exactness of the welded connection. This check ensures that the components are aligned precisely relative to one another and do not have any deviations that could lead to imbalances or functional disturbances. For this purpose, a dial gauge is used, which measures the concentricity accuracy and shows up possible deviations. The dial gauge is a precision measuring instrument which is used for detecting small length variations or deviations from a reference position. It generally comprises a dial plate with a pointer that indicates the measured values, and a measuring pin which transfers the movement of the object to be measured to the dial plate and is in direct contact with the object to be measured. This direct contact also falsifies the quality and meaningfulness of the concentricity test, since the measuring pin in contact with the object to be measured is applied to the object with a certain spring force, which can impair the concentricity.

It follows from this that there are several disadvantages in the current prior art in individual part production. For example, the high setting complexity for the clamping device leads to high scrap rates and extends the production process. The concentricity measurement carried out by the dial gauge is often imprecise, which impairs the quality of the end products. Furthermore, systematic documentation of the measurement results is lacking, which makes the traceability and quality control more difficult.

The aim of the present disclosure is to provide a welding device and a method for welding, which overcomes or at least reduces the disadvantages of the prior art set out above. This is achieved by a device and a method as described herein.

According to the disclosure, the welding device for welding components comprises a linear unit that is configured for moving a component placed thereon back and forth along one direction, an optical measuring unit comprising a detection region directed onto a portion of the linear unit in order to measure a component placed on the linear unit, and a welding unit which is configured for lifting a first component, optionally a sphere, from the linear unit and, after displacement of the linear unit, for welding it to a second component, optionally a wire, placed in the detection region.

The combination of the linear unit, the optical measuring unit and the welding unit provides a welding device which is capable of welding a first component and a second component together in an automated manner. Furthermore, the result of the welding procedure can also be examined with the aid of the optical measuring unit, and depending thereon an adjustment in the interaction of the different units can take place.

Since the components to be welded together can each be displaced on the linear unit, wherein for example the first component is already lifted from the linear unit by the welding unit and thus a relative movement of the two components may occur, it is no longer necessary to insert and position the components manually, with one another, in a clamping device. The positioning of the two components relative to one another takes place by the displacement of the second component on the linear unit, if the first component has already been lifted from the linear unit by the welding unit. As a result, a fully automatic welding procedure can be created, in which the complex setting work on the clamping device is omitted. Finally, the positioning of the two components to be welded together can be performed by the displacement of the linear unit relative to the welding unit.

The optical measuring unit serves to subject the individual components, to be welded together, to a test, in advance, which finds whether the dimensions meet predetermined tolerances. After a completed welding procedure, the optical measuring unit can furthermore be used for checking the welded component with respect to its dimensions and adherence to predetermined tolerances.

According to an optional development of the present disclosure, it can be provided that the welding unit is configured for lifting the first component out of the detection region of the optical measuring unit.

For example, the linear unit can initially move the first component into a detection region of the optical measuring unit, such that the optical measuring unit can determine and check the dimensions of the first component. If the dimensions are then within a predetermined tolerance, the first component is lifted by the welding unit from the linear unit. Subsequently, the linear unit then moves such that the second component, which is to be welded to the first component, is transferred into the detection region of the optical measuring unit. Thus, a check of the dimensions by the optical measurement unit of the second component then takes place, before the welding of the first component and the second component is performed.

According to a further advantageous development of the present disclosure, it can be provided that the optical measuring unit has an accuracy of 1 μm or better. The optical measuring unit is also referred to as a micrometer, and has a very high resolution in order to be able to detect any deviations in the dimensioning of the first component, the second component, or the component to be welded (consisting of the first component and the second component welded thereto).

According to an advantageous modification of the present disclosure, it can be provided that the linear unit is configured for displacing the second component into the detection region of the optical measuring unit following lifting of the first component by the welding unit. In this case, the detection region of the optical measuring unit does not change, relative to the linear unit, not even if the optical measuring unit were to perform a pivot movement in order to be able to view a component, placed in the detection region, from another angle.

According to an advantageous development of the present disclosure it can furthermore be provided, according to the disclosure, that the optical measuring unit is arranged so as to be rotatable relative to the linear unit, in order to measure a component placed in the detection region from different angles, optionally wherein the angle of rotation of the optical measuring unit is at an angle of at least 90°, optionally at least 180°.

It can furthermore be provided that the angle of rotation of the optical measuring unit does not exceed an angle of 180°.

The optical measuring unit that can be arranged so as to be rotatable relative to the linear unit can accordingly view a welded component, which has been formed by welding the first component to the second component, from different angles, and to perform a measurement of the welded component in each of the viewing positions that differ from one another in terms of angle. It can thus be provided that during a pivoting of the optical measuring unit from an initial position with a minimal pivot angle towards an end position with a maximum pivot angle, a measurement that is continuous during the pivot movement, or a plurality of measurements of the welded component from different angles is carried out, such that the concentricity of the welded component can be checked as a result. Advantageously, in the case of the concentricity test that is proposed according to the disclosure, the welded component to be checked is not contacted, such that the inaccuracy in the concentricity test, typically brought about in the prior art by a dial gauge, does not occur. Finally, it is conventional in the case of a dial gauge for a measuring head to contact the component to be checked, and a relative rotation between the measuring head and component is performed, such that in the case of imbalance the measuring head is deflected out of its original position. In order to allow such deflection, however, it is necessary for the measuring head to be pressed with a certain force against the component to be measured, which makes the measurement of the concentricity itself imprecise. Furthermore, the deflection at the dial gauge is transferred via a force sensor to a display.

Advantageously it can be provided according to the present disclosure that an axis of rotation for rotating the optical measuring unit extends in the vertical direction and is optionally oriented orthogonally to the movement direction of the linear unit and/or in parallel with the movement direction of the welding unit, in particular identically to the movement direction of the welding unit.

In this case, the welding unit is movable in the vertical direction, in order to receive a first structural member placed on the linear unit and to yield it therefrom upwards. After placement of the second structural member under the welding unit, the welding unit moves down in the direction of the linear unit and welds the first component, held by the welding unit, to the second component, arranged on the linear unit.

According to a further optional modification of the present disclosure, it can be provided that, for placing at least one first component and at least one second component on the linear unit, a parts carrier is provided, which is releasably coupled to the linear unit.

A parts carrier facilitates the arrangement of a plurality of first components and a plurality of second components in order to form a plurality of welded components. In this case, the parts carrier first enables the parts carrier to be equipped with the components required for the welding process, and can subsequently be coupled to the linear unit. The parts carrier can accordingly be releasably connectable to the linear unit.

The disclosure furthermore relates to a method for welding components, in particular with a welding device, comprising the steps of:
placing a first component, optionally a sphere, and a second component, optionally a wire, on a linear unit,
measuring the first component by an optical measuring unit and checking the correctness and/or the dimensional accuracy of the first component against predefined target values,
receiving the first component by a welding unit and lifting it from the linear unit,
placing the second component by a displacement of the linear unit in the detection region of the optical measuring unit,
measuring the second component by the optical measuring unit and checking the correctness and/or the dimensional accuracy of the second component against predefined target values,
welding the first component, received by the welding unit, to the second component, placed on the linear unit, with the aid of the welding unit, and
performing a concentricity test of the welded assembly, in that the optical measuring unit performs a pivot movement and measures the welded assembly from different angles.

The method according to the disclosure allows for a fully automatic, process-reliable welding result in large quantities. In this case, in contrast to the conventional prior art, complex setting work in the clamping device is omitted, which work has to be provided separately in each case for the components to be welded. Furthermore, the concentricity test is performed with the aid of the optical measuring unit, such that any falsifications on account of the sensing element of a dial gauge, as is conventional in the prior art, cannot occur. Furthermore, automatically performing the welding also allows for uninterrupted documentation with respect to the dimensions of the first and second components used and of the welded component. Overall, this leads to a welding method in which the scrap is significantly reduced compared with the method from the prior art. Thus, it is no longer (or only very much more rarely) the case that an incorrect setting of the clamping device, in which the first component has been placed relative to the second component, creates a welded component of which the concentricity is not optimal, and which cannot fulfil the predetermined tolerances. With regard to the achievable speed, too, the method according to the disclosure is preferable compared with the prior art.

It can advantageously be provided according to the present disclosure that the respective component is sorted out on the basis of the measurement of the first and/or the second component, or the following step is performed with the respective component.

The optical measuring unit can use the results, obtained during measurement of the first component or of the second component, to terminate the welding procedure and instead to use a first component or a second component of which the dimensions are within predetermined tolerance values.

According to an optional development of the present disclosure, it can be provided that the linear unit is actuated on the basis of the measurement of the first component and before the first component is received by the welding unit, in order to position the first component exactly for reception by the welding unit.

However, the linear unit is configured such that it can position the second component exactly relative to the welding unit. The welding unit itself does not have to be configured to be movable in the direction in which the linear unit can move the second component placed thereon, and therefore a simply designed welding unit can be used. The welding unit only has to be capable of receiving the first component from the linear unit placed under the welding unit, and lifting it from the linear unit, such that a mobility of the welding unit in the direction perpendicular to the movement direction of the linear unit (typically vertical direction) is sufficient. This simplifies the construction of the welding device. Furthermore, it can be provided that the lifting of the first component from the linear unit takes place in the region of the linear unit which is the detection region of the optical measuring unit. Thus, in other words, the first component is lifted out of the detection region of the optical measuring unit, which covers a region of the linear unit.

According to a further optional modification of the present disclosure, it can be provided that the linear unit is actuated on the basis of the measurement of the second component and before the welding by the welding unit, in order to position the second component exactly for welding to the first component received by the welding unit. Following an exact positioning of the second component, the welding unit, which has received the first component, can move downwards and bring the first component so close to the second component that welding of the two components can be carried out.

Furthermore, according to a further development of the present disclosure, it can be provided that the movements performed by the linear unit for placing the first component and/or the second component are stored in order to optimize the movements performed by the linear unit for placing the first component, depending on results of the concentricity test, with the aid of an optimization algorithm which is optionally based on artificial intelligence.

Thus, in this case, the position or the positions of the second component relative to the welding unit can be studied with regard to whether the respectively resulting welded component has a satisfactory concentricity or is outside the predetermined tolerances. Depending on a consideration of a plurality of positions of the second component relative to the welding unit, an improvement of the positioning can then be performed with the aid of an optimization algorithm. In this case it can be provided that the optimization algorithm uses machine learning and/or artificial intelligence methods in order to optimize the matching of the different units of the device to one another.

According to a further optional modification of the present disclosure, it can be provided that after the concentricity test the measurement results obtained by the optical measuring unit are stored in a file in order to carry out documentation. In this case, the documentation can for example include the dimensions, obtained by the optical measuring unit, of the first component, the second component and/or the welded component. Furthermore, yet further information such as the total duration of the welding procedure, the date of the welding procedure, the type of the components used, or similar information, can also be documented.

According to an advantageous development of the present disclosure, it can be provided that a plurality of first components and a plurality of second components is arranged on the linear unit, and after welding of a first component to a second component, welding of a further first component to a further second component is continued with.

According thereto, the linear unit can thus be equipped with a plurality of first components and a plurality of second components, such that after welding of a first component to a second component, it is possible to continue with the welding of a further first component to a further second component.

According to a further modification of the present disclosure, it can be provided that the components to be welded are part of an electrohydraulic servo valve, in particular a sphere, which is to be welded to a spring, in particular a spring wire.

### BRIEF DESCRIPTION OF THE FIGURES

Further features, details and advantages of the disclosure are clear from the following description of the figures, in which:

FIG. 1: is a schematic view of a joining plant,

FIG. 2A-FIG. 2B: schematically show an implementation of the method according to the disclosure, and

FIG. 3: is a schematic view from above of a welding device according to the disclosure.

### DETAILED DESCRIPTION

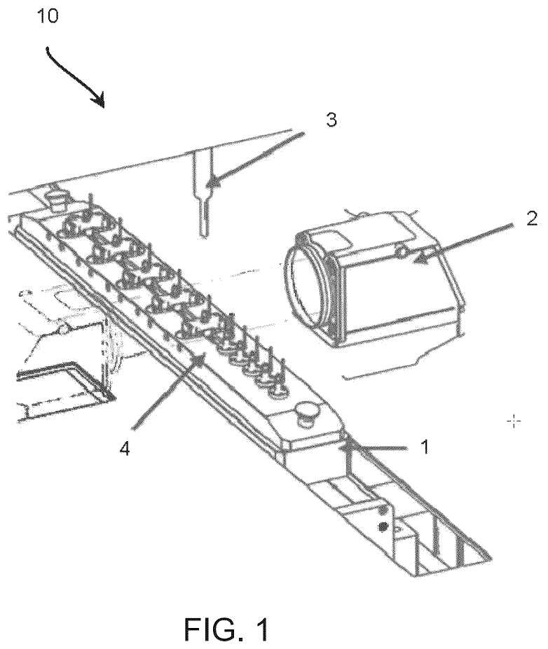

FIG. 1 is a schematic view of a joining plant, which also comprises or can constitute the welding device 10 according to the present disclosure.

The linear unit 1 is visible, on which a plurality of components is placed. In this case, a first of the plurality of components is to be welded to a second of the plurality of component via a welded joint, in order to form a welded component.

The linear unit is capable of moving the plurality of components back and forth in one direction, wherein the displacement path of the linear unit crosses a detection region of an optical measuring unit 2. The optical measuring unit 2 can now measure the component, placed in its detection region, exactly with respect to its dimensioning and its positioning relative to the welding unit.

Furthermore, the welding device 10 according to the disclosure comprises a welding unit 3 which is configured for receiving and lifting a first component from the linear unit 1 in order, after displacement of the linear unit 1, in which a second component has been placed directly under the welding unit 3, to bring about welding together of the two components.

According to an advantageous embodiment of the welding device 10, in this case the procedure of welding also takes place within the detection region of the optical measuring unit 2, in order for example after welding, in which the two components joined together have been welded together, to perform a measurement of the still welded component, in order to find out whether the welded component corresponds to the predetermined dimensioning specifications or exceeds tolerances.

A superordinate control unit, which is connected to the linear unit 1, the optical measuring unit 2 and the welding unit 3 and stores the respective parameters of the different settings and actions of the welding device 10 during welding, is not shown. This information can be used subsequently to perform an optimization algorithm which aims to improve the welding. In this case, the optimization algorithm can work with the aid of artificial intelligence and automatically perform an optimization of the settings and actions of the welding device 10.

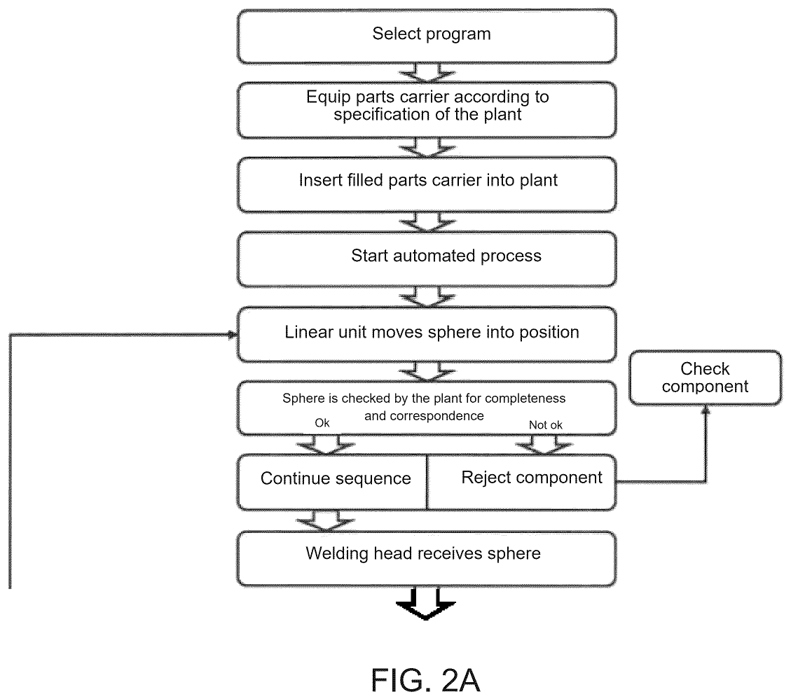

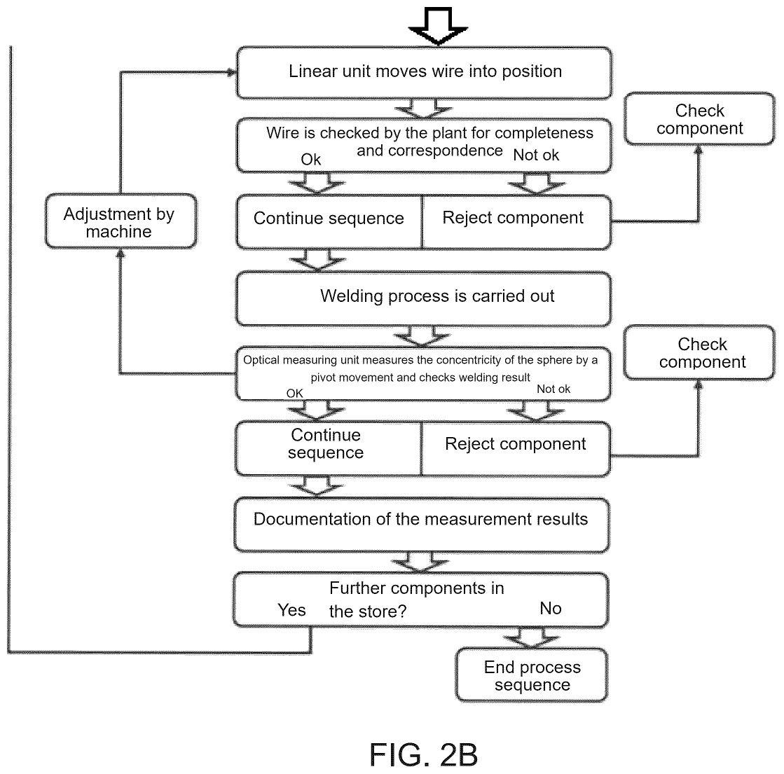

FIG. 2A-FIG. 2B show a flowchart of the method according to the disclosure for welding, wherein the flowchart, on account of its size, has been divided over two different pages of drawings, FIG. 2A and FIG. 2B.

Firstly, a specific program for welding two constituent parts is selected, and a parts carrier 4 is equipped according to the specifications of the plant. In this case, in the further course of the method the parts carrier can interact with the linear unit, such that the linear unit is capable of shifting the components arranged in the parts carrier 4. Thus, if the parts carrier 4 has been filled and inserted into the plant, the machine that operates according to the method starts the welding process.

Initially, the first component is moved to a predetermined position in which the optical measuring unit has its detection region.

Then, the first component, for example a sphere, is checked for correctness and dimensional accuracy with the aid of the optical measuring unit, such that it is possible to identify whether or not the component is within the predetermined tolerance limits. If this is not the case, this leads to rejection of the component, such that subsequently an exchange and a manual check of the rejected component can take place. If, in contrast, the dimensional accuracy of the first component is correct, exact positioning of the first component can take place, for grasping by the welding unit. In this case, for example the first component is positioned directly under the welding unit, such that lowering of the welding unit makes it possible for the first component to be received.

If the first component has been removed or lifted by the welding unit out of the parts carrier or from the linear unit, the linear unit now displaces the second component, for example a wire, into a detection region of the optical measuring unit, in order to also check the second component for its dimensional accuracy and its correctness.

Here, too, in the case of a deviation from allowable tolerance values the second component is rejected, whereas the joining procedure is continued if the second component is acceptable. Then, the second component is positioned exactly, relative to the welding unit, by the linear unit, such that lowering of the welding unit, which holds the first component, positions the two components relative to one another in such a way that welding with the aid of the welding unit is possible.

If the positioning of the second component is completed, lowering of the welding unit and welding of the two components occurs, such that the welded component results.

The components welded together are measured by the optical measuring unit such that a difference in the dimensions of the joined component up to the target dimension of the welded component is determined. In order to be able to determine the concentricity of the welded component here too, it is necessary to measure the welded component not only from one angle, with the aid of the optical measuring unit, but rather from different angles. For this reason, the optical measuring unit is pivotable relative to the linear unit, such that the welded component, which is placed on the linear unit, can be measured by the optical measuring unit 2 from different angles. In this case, the measuring by the optical measuring unit can be carried out continuously during a pivot movement, or can also be performed intermittently at different positions, during the pivot movement.

If the concentricity of the component is detected as being within predetermined tolerances, the measurement results relating to the welded component are documented, in that the associated information is stored in a file.

The measurement results with respect to the concentricity of the welded component can also be used to optimize the positioning of the second component relative to the welding unit. This can take place with the aid of an adjustment of the parameters during operation of the linear unit, with the aid of machine learning algorithms and/or artificial intelligence. In this case, an optimization in the positioning of the second component by a changed actuation of the linear unit is performed, depending on the measured position of the second component and a result in the concentricity test, in order to achieve an even more exact alignment of the second component relative to the first component before the welding is carried out.

Furthermore, after documentation of the measurement results, the method checks whether further components are still present in the parts carrier, which have not yet been welded together. If this is the case, the linear unit is moved such that the first component is arranged under the welding unit, such that this can be received by the welding unit and the linear unit can position the second component under the linear unit. The welding procedure for connecting the first component and the second component is thus performed again.

If, in contrast, it is found that no further components are arranged in the parts carrier 4, the method is ended.

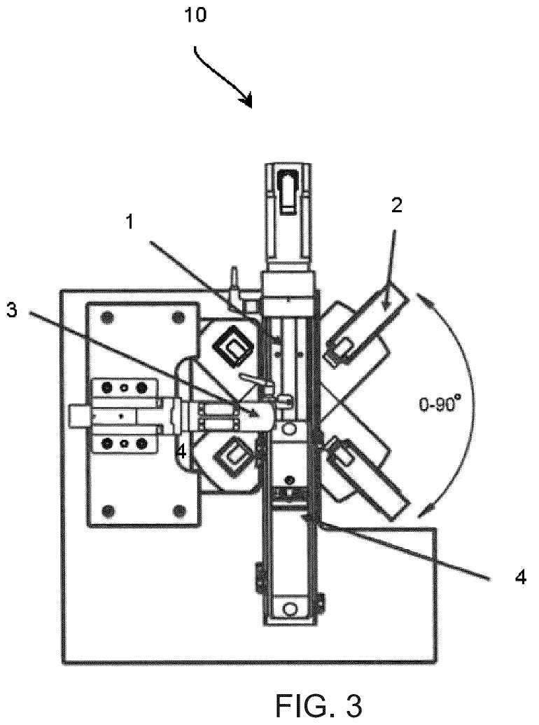

FIG. 3 is a plan view of a welding device 10 according to the disclosure, which comprises the same components as the welding device 10 from FIG. 1. In this case, however, the pivotability of the optical measuring unit 2 is visible, which unit can, in the figure shown, assume a pivot angle of 0 to 90°. It can furthermore be seen that the parts carrier 4 is movable back and forth along a movement direction of the linear unit 1, such that different components arranged in the parts carrier can be arranged under the welding unit 3. The ability of the optical measuring unit 2 to twist is necessary for testing the concentricity of the welded component, since as a result the welded component can be measured from different viewing angles, such that a concentricity test can be performed. An advantage of the tiltable optical measuring unit 2 is that, in contrast to the conventional prior art, no physical contact with the welded component to be measured is required, which could falsify the concentricity test. A tiltability of the optical measuring unit from a first starting position to a second starting position which are separated from one another by 45° is adequate for a sufficient accuracy of the concentricity test. The tiltability of the optical measuring unit 2 in a range of 0 to 90° is shown in FIG. 2, wherein, however, the disclosure also includes alternative angular ranges. In the embodiment shown according to FIG. 3, the pivot axis for tilting the optical measuring unit 2 is oriented perpendicularly to the movement axis of the linear unit, in particular vertically. The movement axis of the line unit 1 is advantageously oriented horizontally.

By means of the disclosure, the components to be welded are aligned to one another automatically and with high precision (dimensional fidelity and correctness checked. The optical measuring unit is used for this purpose. The checking of the concentricity and the welding result also takes place inline, in an automated manner.

Furthermore, the optimization algorithm, which can be based on machine learning, makes it possible to continuously improve the results of the welding process and the work results of the welding device.

### List of Reference Signs

1 linear unit
2 optical measuring unit
3 welding unit
4 parts carrier
10 welding device

1. Welding device for welding components, comprising:
a linear unit which is configured for moving a component placed thereon back and forth along one direction,
an optical measuring unit comprising a detection region directed onto a portion of the linear unit, in order to measure a component placed on the linear unit, and
a welding unit which is configured for lifting a first component from the linear unit and, after displacement of the linear unit, for welding it to a second component placed in the detection region.

2. Welding device according to claim 1, wherein
the welding unit is configured for lifting the first component out of the detection region of the optical measuring unit.

3. Welding device according to claim 1, wherein the optical measuring unit has an accuracy of 1 μm or better.

4. Welding device according to claim 1, wherein the linear unit is configured for displacing the second component into the detection region of the optical measuring unit following lifting of the first component by the welding unit.

5. Welding device according to claim 1, wherein the optical measuring unit is arranged so as to be rotatable relative to the linear unit, in order to measure a component placed in the detection region from different angles.

6. Welding device according to claim 5, wherein an axis of rotation for rotating the optical measuring unit extends in the vertical direction and is oriented orthogonally to the movement direction of the linear unit and/or in parallel with the movement direction of the welding unit, including identically to the movement direction of the welding unit.

7. Welding device according to claim 1, wherein for placing at least one first component and at least one second component on the linear unit a parts carrier is provided, which is releasably coupled to the linear unit.

8. Method for welding components, r with a welding device according to claim 1, comprising the steps of:
placing the first component, and a second component on a linear unit,
measuring the first component by an optical measuring unit and checking the correctness and/or the dimensional accuracy of the first component against predefined target values,
receiving the first component by a welding unit and lifting it from the linear unit,
placing the second component by a displacement of the linear unit in the detection region of the optical measuring unit,
measuring the second component by the optical measuring unit and checking the correctness and/or the dimensional accuracy of the second component against predefined target values,
welding the first component received by the welding unit to the second component placed on the linear unit, with the aid of the welding unit, and
performing a concentricity test of the welded assembly, in that the optical measuring unit performs a pivot movement and measures the welded assembly from different angles.

9. Method according to claim 8, wherein the respective component is rejected on the basis of the measurement of the first and/or the second component, or the following step is performed with the respective component.

10. Method according to claim 9, wherein the linear unit is actuated on the basis of the measurement of the first component and before the first component is received by the welding unit, in order to position the first component exactly for reception by the welding unit.

11. Method according to claim 8, wherein the linear unit is actuated on the basis of the measurement of the second component and before the welding by the welding unit, in order to position the second component exactly for welding to the first component received by the welding unit.

12. Method according to claim 8, wherein the movements performed by the linear unit for placing the first component and/or the second component are stored in order to optimize the movements performed by the linear unit for placing the first component, depending on results of the concentricity test, with the aid of an optimization algorithm which is based on artificial intelligence.

13. Method according to claim 8, wherein after the concentricity test the measurement results obtained by the optical measuring unit are stored in a file in order to carry out documentation.

14. Method according to claim 8, wherein a plurality of first components and a plurality of second components is arranged on the linear unit, and after welding of a first component to a second component, welding of a further first component to a further second component is continued with.

15. Method according to claim 8, wherein the components to be welded are part of an electrohydraulic servo valve, EHSV, which is to be welded to a spring.

16. Welding device according to claim 1 wherein the first component is a sphere and the second component is a wire.
